(19) United States
(12) Patent Application Publication
(10) Pub. No.: US 2026/0258897 A1
(43) Pub. Date: Sep. 3, 2026

(54) ROBOT FOR TRENCHLESS PIPELINE AND MANHOLE REHABILITATION

(71) Applicants: Matthias Manuel MÜLLER, Hagenbrunn (AT); Armin FRANZ, Wien (AT)

(72) Inventor: Matthias Manuel MÜLLER, Hagenbrunn (AT)

(73) Assignees: Matthias Manuel MÜLLER, Hagenbrunn (AT); Armin FRANZ, Wien (AT)

(21) Appl. No.: 18/857,945

(22) PCT Filed: Apr. 13, 2023
(86) PCT No.: PCT/EP2023/059685

§ 371 Date: Oct. 18, 2024

(30) Foreign Application Priority Data
Apr. 20, 2022 (AT) A 50265/2022

(51) Int. Cl. F16L 55/34; F16L 55/44; F16L 101/12; F16L 101/18; F16L 101/30

(52) U.S. Cl. CPC F16L 55/34; F16L 55/44; F16L 2101/12; F16L 2101/18; F16L 2101/30

(57) ABSTRACT

The invention relates to a robot for trenchless pipeline and manhole rehabilitation, said robot comprising: at least two expansion segments which each have a self-locking expansion mechanism with at least one double scissor lift for expanding and pressing against the pipe or manhole wall; and at least one advancing segment between two expansion segments, one expansion segment being the frontmost segment, wherein the expansion mechanism has, for actuating the double scissor lift, a lead screw which is rotatably mounted in the expansion segment so as to be oriented in the movement direction of the robot.

The invention relates to a robot for trenchless pipeline and shaft rehabilitation. The robot is designed in particular for opening hardened liner pipes, inspecting and cleaning pipelines, clearing blockages and removing deposits in pipes.

Robots are required when maintaining sewage pipes, drinking water pipes and ventilation shafts in order to be able to carry out the work without exposing the pipe or shaft. Usually equipped with an image sensor and a tool, mostly a milling tool, these robots have until now been controlled manually. In the past, this was primarily necessary because this equipment could not determine the position of the individual components or control the actuators in a sufficiently controlled manner. It is possible to automate movements by using electric motors for precise positioning and, for example, encoders for exact position determination of the moving components. For example, speed control can be used to force a continuous forwards or backwards movement, and a specific point in the pipe can be approached if the position of the robot in the pipe can be measured. There are some applications where automation of the robot may be judicious, such as the independent removal of deposits from pipe walls using a brush attachment.

WO 2021/052868 A1 discloses a sewer exploration robot, which consists of two segments, which are provided with retracting and extending support modules and have cylindrical housings, and a positioning system arranged between these segments. Each support module comprises three scissor lifts which can be retracted and extended offset by 60° to each other around the circumference of the respective segment and are respectively 1.5 times scissor lifts, which can be radially extended from the segments such that their stroke is limited by the diameter of the segments. The positioning system which can adjust the position of the two segments relative to each other has at least one pair of linear actuators, which are oriented parallel to the longitudinal axis of the robot, and are coupled to one of the segments in order to be able to position this segment relative to the other segment by independent translational movements.

The object of the invention is to provide a robot for trenchless pipeline and shaft rehabilitation, which can be used in differently sized pipelines and shafts and can be precisely moved therein, while being particularly well and reliably supported on the inner wall of the pipeline or shaft and can be positioned centred at any point in the pipe or shaft in order to carry out rehabilitation work.

This object is achieved with a robot having at least two expansion segments which have a self-locking expansion mechanism with at least one double scissor lift for expanding and pressing against the pipe or shaft wall, at least one advancing segment between two expansion segments, one expansion segment being the foremost segment, wherein the expansion mechanism has, for actuating the double scissor lift, a lead screw, which is rotatably mounted in the expansion segment so as to be orientated in the movement direction of the robot.

The overall design of the robot consisting of at least two expansion segments with double scissor lifts, with respectively an advancing segment positioned between the expansion segments and one expansion segment being the foremost segment enables the robot to move in a “worm-like” manner in the pipe or shaft, on the one hand, and the foremost segment to be precisely positioned at a specific point, on the other hand. The double scissor lifts in the expansion segments and their orientation and actuation via lead screws running in the movement direction of the robot provide a large stroke such that the robot can be used in pipes and shafts with a wide variety of dimensions. Moreover, the double scissor lifts enable support elements, such as feet, to be arranged parallel to the movement direction of the robot at their outer ends, thereby ensuring particularly good and reliable support of the double scissor lifts on the pipe and shaft inner wall.

In one particularly preferred embodiment, the expansion segments respectively have two double scissor lifts which can be expanded in opposite directions and can be actuated together via the lead screw. This measure is particularly advantageous for use of the robot in pipelines and shafts with a particularly large inner diameter.

In another preferred embodiment, all segments of the robot are coupled together via connection pieces, which are in particular stiffened and torsionally rigid hose pieces. Such connection pieces between the segments make the robot exceptionally manoeuvrable for movement through bends in the pipe or shaft.

In another advantageous embodiment of the robot, on the expansion segment forming the foremost segment, a lifting device is provided with a head mounted thereon and provided with at least one tool and/or measuring apparatus, wherein the lifting device is designed in particular to rotate and/or lift and lower the head such that the head can be particularly precisely positioned, for example for carrying out milling work.

The lifting device preferably has a drive element and a locking device, wherein the drive element is connected to the locking device by means of a connection shaft such that the lifting device can be controlled accordingly and, if required, also unlocked, for example to prevent a defect caused by external forces.

According to another preferred embodiment of the robot, two expansion segments coupled to one another by a connection piece are connected to the lifting device. In this way, the front part of the robot can be positioned at the respectively desired point in a particularly stable manner and optimally centred.

In this respect, it is also particularly advantageous if these two consecutive expansion segments and possibly other provided and consecutive expansion segments can be rotated relative to one another. Such mutual rotation is in particular advantageous for the two expansion segments connected to the lifting device.

In another preferred embodiment of the robot, it is provided that it has at least two advancing segments located respectively between two expansion segments. In this way, the step-by-step, “worm-like” movement of the robot is essentially smoothed out, such that, for example, by controlling the foremost expansion segment, this segment can be moved smoothly and, in particular, the head can be moved forwards and backwards evenly and continuously.

In another advantageous embodiment, each advancing segment has a self-locking advancing mechanism for increasing or reducing the distance between the two expansion segments coupled to the advancing segment, wherein this advancing mechanism has in particular a piston, which is mounted on the one end of a connection piece and which can be moved forwards and backwards by a spindle drive. The advancing segments therefore enable the robot to move gradually in the pipe or shaft through a simple movement of the connection pieces.

The rearmost or back component of the robot is in particular a plug segment, to which a main connecting plug of a supply cable, which is preferably in the form of a push cable, can be connected.

One embodiment of the robot is particularly advantageous with an emergency power supply with electronics, which is preferably contained in the plug segment and is provided for the temporary further supply of the internal control components if the power supply is disrupted in order to retract the double scissor lifts of the self-locking expansion segments, the self-locking advancing mechanisms of the advancing segments and also, if necessary, unlock the lifting device. This ensures that the robot can be removed from the pipe or shaft without any damage if the power supply is interrupted.

At least one of the following belongs to the tools and/or measuring apparatuses mounted on the head: an ultrasonic measuring apparatus for measuring the thickness of the pipe wall, a laser measuring apparatus for 3D measurement of the pipe and deposits, a powerful light source for spot hardening a resin tube, a laser for cutting away material or engraving the pipe wall, a motor with a brush or a milling head.

It is also advantageous if an image sensor with a view of the tool(s) is mounted on the head, to transmit a live image to an operating unit and to position the robot at a specific point.

One embodiment of the robot is particularly user-friendly in which programmed control is provided for automatically moving to a defined point in the pipe or shaft system and/or for autonomous milling or grinding of pipe or shaft walls in previously defined areas.

The invention will be described in more detail below based on the figures. In the drawings:

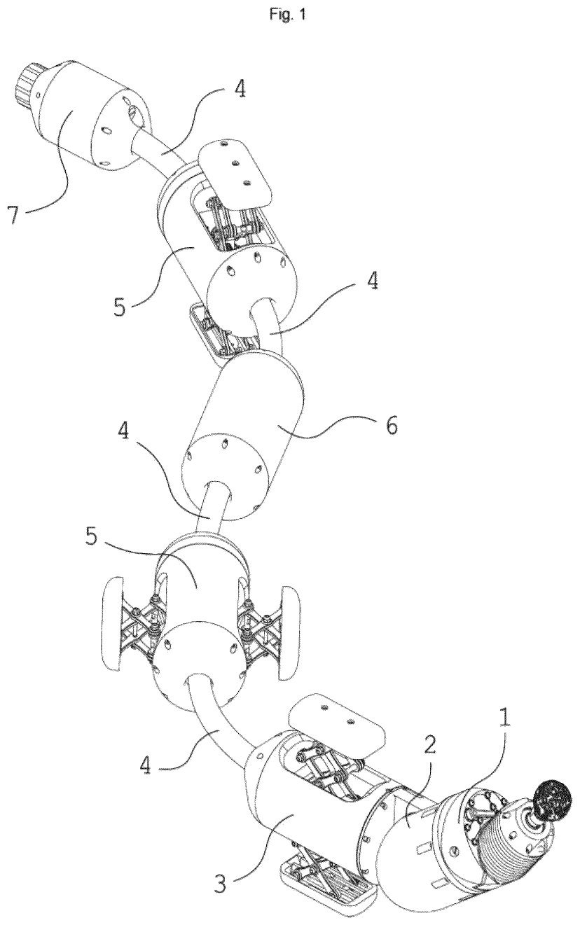

FIG. 1 shows a view of one embodiment of the robot,

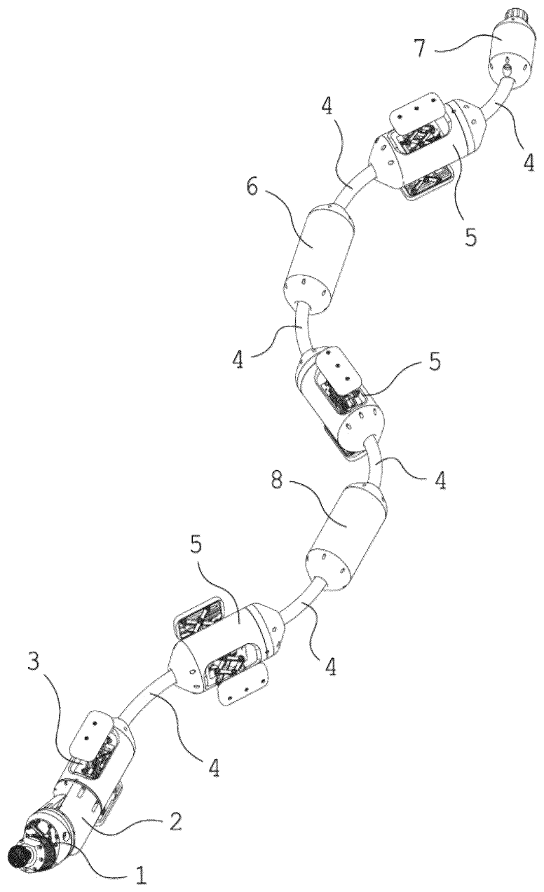

FIG. 2 shows a view of another embodiment of the robot,

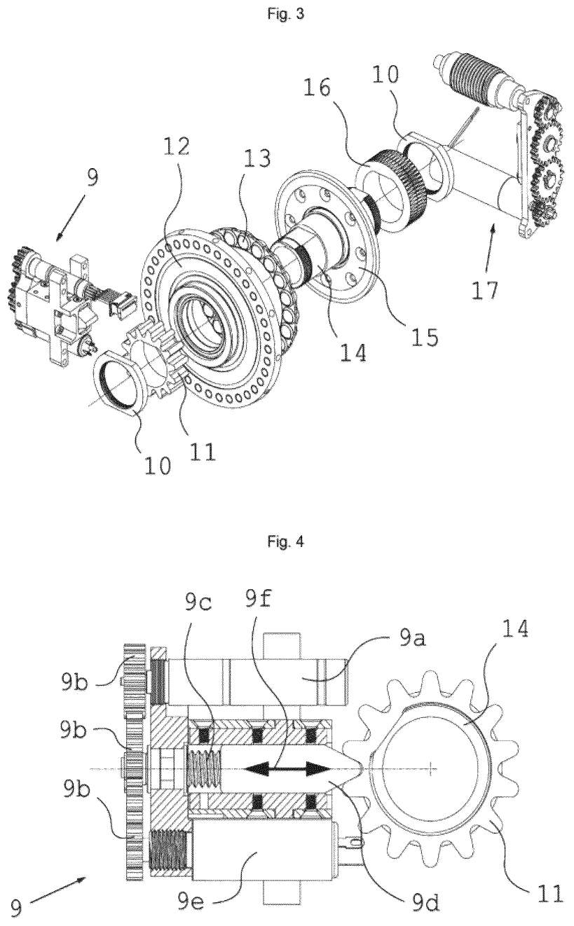

FIG. 3 shows an exploded view of the mechanism of a lifting device,

FIG. 4 shows a view of the mechanism for locking or unlocking a moving part of the lifting device,

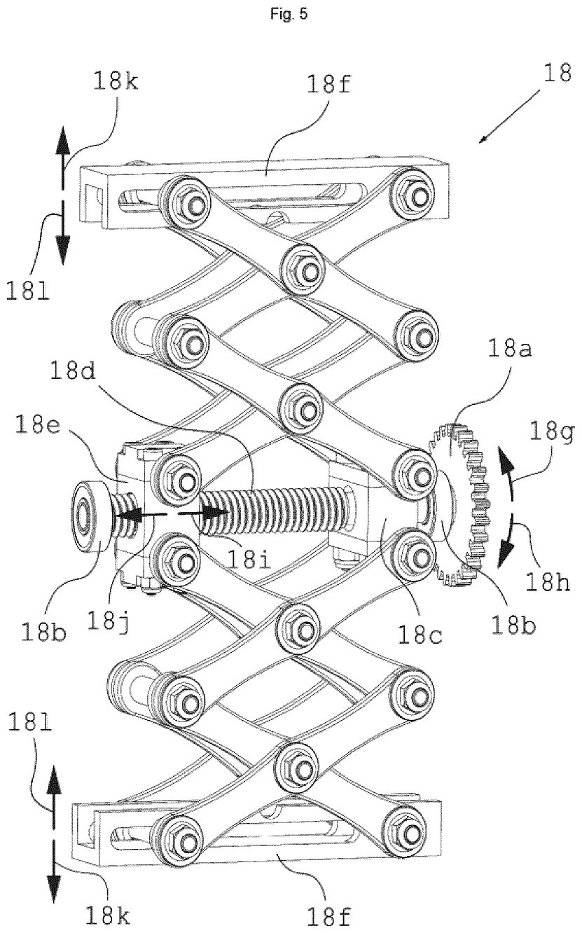

FIG. 5 shows a view of the mechanism for expanding expansion segments and

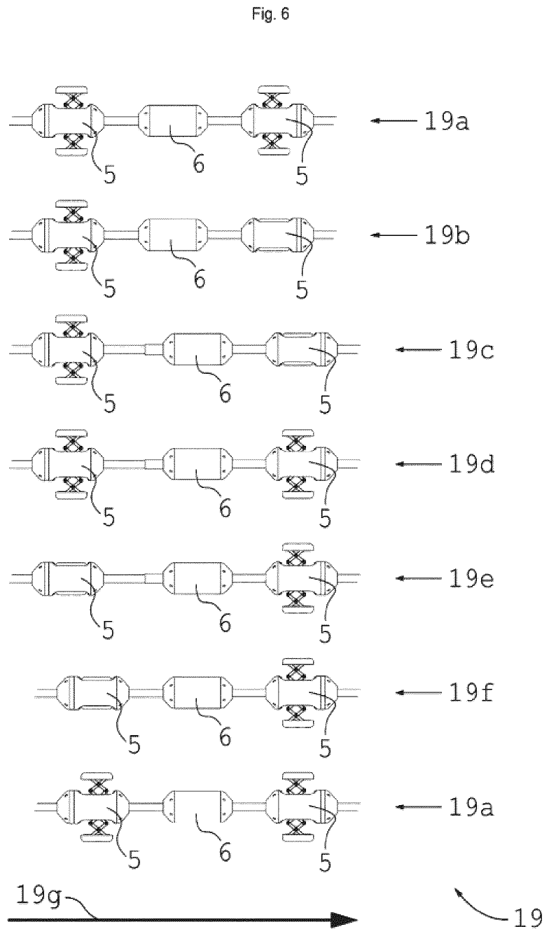

FIG. 6 shows a full step of the worm-like movement of the robot.

The robot has a head 1 (FIG. 1, FIG. 2), on which various tools and measuring apparatuses can be mounted, such as an ultrasonic measuring apparatus for measuring the thickness of the pipe wall, a laser measuring apparatus for 3D measurement of the pipe and deposits incl. precise damage patterns, a powerful light source for spot hardening a resin tube, for example, a laser for cutting away material or engraving the pipe wall or a motor with a brush or a milling head, but preferably there is also always an image sensor located therein with a view of the tool. The image sensor and the live image transmitted to the operating unit is not only required for control when using a tool, but also to position the robot in the pipe at the right point.

The head 1 is attached to a lifting device 2, which in combination with a rotating device, for example in the segment 3 coupled to the lifting device 2, enables control of the head 1 in at least two axes. Depending on the required force, the lifting device 2 can be designed in different ways and include different types of gears. In the embodiment shown in FIG. 3, the lifting device 2 consists of two assemblies, a rigid and a movable part. The rotation between the parts is made possible by a worm gear 17, which is self-locking and would therefore block if the robot were to be pushed into or pulled out of the pipe by force without the lifting device 2 being controlled accordingly by the control system to suit the geometry of the pipeline, in particular in bends. Therefore, a locking device 9 is located in the non-driven part, which can decouple the shaft 14 and the part 12 or 15 accommodating it in such a way that the parts are still connected, but the rotation of the shaft 14 is made possible or the rotation of the shaft 14 is no longer transmitted to the part until it is locked again. The lifting device 2 can be moved in the locked state by external forces such as those that occur when the robot is moved in the pipe at bends and branches without the self-locking worm gear 17 being subjected to load or the shaft 14 being blocked.

To be able to move the head 1 in the pipe, in particular in large pipes, to any desired point, the front part of the robot has to be centred in the pipe. This job is carried out by the segment 3 on which the lifting device 2 and thus also the head 1 are mounted and which optionally has a rotating mechanism. The segment must have a mechanism with which expansion in the pipe is possible. In this embodiment, a double scissor lift 18 is used for this purpose. Feet can be expanded in one and in the opposite direction and then make contact with the pipe wall and guide and centre the segment and thus the entire front part. The use of double scissor lifts can result in a sufficiently large change in the cross-section of the segment 3 and the robot can be used for a plurality of pipe dimensions. In previously known systems which are predominantly pneumatically driven, rubber air bubbles are used to expand the segment 3, which, however, close and seal the pipe and prevent accumulated water or another medium from running off. Thanks to the double scissor lifts 18, which do not increase the overall diameter of the expansion segment 3, the medium can continue to drain, and backflow can be prevented. In the case of the front expansion segment 3, the feet, which can be pressed against the pipe wall but can also be loosened again slightly when extended to facilitate sliding forwards or backwards when the front section is moved, should have the best possible sliding properties in combination with the pipe wall. They can, for example, be made of metal or plastic.

All segments of the robot are connected via connection pieces 4, such as stiffened, and particularly torsionally rigid hose pieces.

The other segments 5 are very similar to the front segment 3, also consist of mechanisms for expansion and attachment in the pipe, but their feet should have the highest possible adhesion properties, for example using rubber feet, as these segments 5 are necessary so that the robot can be held in a pipe and can move forwards and backwards independently. Furthermore, these segments 5 do not necessarily need to have the ability to rotate. However, in the embodiments shown in FIGS. 1 and 2, they can rotate so that the robot can align itself vertically by alternately opening and closing the feet of the various segments 5 in combination with the rotations and, if necessary, a gyroscope sensor for position detection. When two double scissor lifts 18 are used, it is advantageous if the segment 5 or 3 is oriented such that the scissor lifts are expanded upwards and downwards, as otherwise lateral forces occur due to shear on the pipe wall, which can damage the mechanics of the double scissor lifts 18 and the expansion force of the double scissor lifts 18 decreases with an inclined position in the pipe.

As shown in FIGS. 1 and 2, however, it can be advantageous to deliberately orient one of the two foremost segments 3 or 5 rotated by, for example, 90 degrees, i.e. lying flat, as this can increase the stability of the front part, in particular the lateral wobbling of the front part is reduced, in particular during milling or brushing with a corresponding tool on the head 1. For this purpose, it makes sense to couple these two foremost segments 3 or 5 one behind the other without an advancing segment 6 in-between so that the stabilizing effect is as great as possible.

The advancing segments 6 enable, in combination with the expansion segments 3 or 5, a step-by-step, worm-like drive as shown in FIG. 6. The advancing mechanism for increasing or reducing the distance between the two expansion segments 5 coupled to the advancing segment 6 is implemented in this embodiment such that a sealed piston, on which one end of a connection piece 4 is mounted, can be moved forwards and backwards by a spindle drive.

The plug segment 7 is the rearmost part of the robot, to which the main connecting plug of the supply cable, which is preferably in the form of a push cable, is connected. In addition, in this embodiment, the plug segment 7 includes an emergency power supply with electronics for monitoring the main supply. Due to the use of partly self-locking gears and the clamping of the robot in the pipe, the apparatus could no longer be removed from the pipe without exposing the pipe or destroying the apparatus in the event of a cable break or defect in the supply unit, for instance. Therefore, an emergency power supply is designed such that this can store enough energy to retract the self-locking expansion mechanisms of the expansion segments 3 and 5 as well as the self-locking advancing mechanisms of the advancing segments 6 again and, if necessary, unlock the lifting device 2 in such an event. As a result, the robot is once again as compact and bendable as possible and can once again be removed from the pipe. For example, the emergency power supply can consist of capacitors that can withstand many charging cycles and have a significantly shorter charging time compared to conventional accumulators.

FIG. 1 shows the robot comprising a plurality of expansion segments 3 or 5, an advancing segment 6 as well as another segment 7, which are coupled with connection pieces 4. In this embodiment, stiffened hoses are used as connection pieces 4. The front part of the robot consists of an expansion segment 3 for radial clamping in the pipe, a lifting device 2 and the head 1 fixed thereon. In this embodiment, the head 1 comprises an image sensor with corresponding lens, a light as well as a windscreen wiper for cleaning dirt from the protective glass in front of the lens as well as a milling motor with milling tool.

FIG. 2 shows an expanded embodiment compared to FIG. 1, comprising a further expansion segment 5 as well as a further advancing segment 8, which can smooth out the gradual movement which results from the interaction of at least two expansion segments 3 or 5 and at least one advancing segment 6 such that the front part of the robot, in particular the head 1 can be moved forwards and backwards uniformly and continuously.

FIG. 3 shows an exploded view of the mechanism of the lift 2. The lift 2 comprises a rigid part with which a bearing insert 15 is connected and a moveable part with which a bearing insert 12 is connected. These are optionally mounted and clamped together with an axial bearing 13 to increase the stability of the entire structure. On the hollow shaft 14 protruding from the rigid into the moving part, a worm wheel 16 is mounted on one end and a detent wheel 11 is mounted on the other end and secured with nuts 10 in this embodiment. In connection with the detent wheel 11, a device 9 forms a locking mechanism (FIG. 4) to mechanically couple or decouple the moving part, with which the bearing insert 12 is connected, radially with or from the shaft 14. The hollow shaft 14 is driven by a drive unit 17 with a worm on the side of the worm wheel 16 and when the hollow shaft 14 and the moving part of the lift are radially locked by the locking mechanism (FIG. 4), the moving part of the lift can thus be moved and positioned in a targeted manner in relation to the rigid part by control of the drive unit 17. The hollow shaft 14 provides the option of routing cables or media-carrying lines through the entire lift 2.

FIG. 4 shows the mechanism for locking or unlocking the moving part of the lift 2 and the hollow shaft 14, comprising a motor 9a, a potentiometer 9e and a lead screw 9c, which are coupled via a gear, in this embodiment consisting of gear wheels 9b. A detent element 9d, which can form a positive connection with the detent wheel 11, is moved linearly along the axis of the lead screw 9c by rotating it, as illustrated by the arrows 9f. The potentiometer 9e is used to set the position of the detent element 9d, but the motor 9a can also consist of an encoder instead, for example, or the position of the detent element is defined by contact pressure or time.

FIG. 5 shows the mechanism for expanding the segments 3 and 5. The lead screw 18d is rotatably mounted by the bearings 18b in a segment 3 or 5 and can be driven via the gear wheel 18a. In this illustration, the remainder of the segment 3 or 5 has been omitted and the scissor lifts are mounted on block 18c, which would otherwise be a part of the segment housing, which, however, has been omitted for a more comprehensible illustration. The block 18c and the two bearings 18b are unchangeably fixed in their position. The nut 18e moves along the axis of the lead screw 18d when the lead screw 18d is driven. The two mounting parts 18f of the segment feet are connected to the moveable nut 18e and the rigid block 18c by double scissor lifts. A rotation in direction 18g on the gear wheel 18a moves the nut 18e in direction 18i, this movement is deflected by the double scissor lifts and the mounting parts 18f of the segment feet move in direction 18k. Likewise the other way around, when the gear wheel 18a and the lead screw 18d connected thereto are rotated in direction 18h, the nut 18e is moved in direction 18j and the mounting parts 18f are moved by the double scissor lifts in direction 18l. Rotation in direction 18g thus causes the segment 3 or 5 or the segment feet to expand and rotation in direction 18h causes them to contract.

FIG. 6 shows a full step of the worm-like movement 19 in direction 19g.

To start, in position 19a, both expansion segments 5 are still expanded, i.e. spread in the pipe or shaft, and the advancing segment 6 is contracted.

In position 19b, the front expansion segment 5 in direction 19g, in this illustration the right-hand one, is contracted and ready for movement as it is no longer expanded.

In position 19c, the advancing segment 6 is axially expanded and has moved the front, contracted expansion segment 5 as it expands.

In position 19d, both expansion segments 5 are once again expanded and spread in the pipe or shaft.

In position 19e, the rear expansion segment 5, in this illustration the left-hand one, is retracted and ready for movement.

In position 19f, the advancing segment 6 is retracted once again and has moved the rear, retracted expansion segment 5. Then the rear expansion segment 5 expands once again and the robot is once again in the starting state 19a, but moved one step further in direction 19g.

At all times, at least one expansion segment 5 was expanded and fixed the robot in the pipe or shaft to prevent the robot from slipping or sliding.

1. Robot for trenchless pipeline and shaft rehabilitation having at least two expansion segments which each have a self-locking expansion mechanism with at least one double scissor lift for expanding and pressing against the pipe or shaft wall, at least one advancing segment between two expansion segments, one expansion segment being the foremost segment, wherein the expansion mechanism has, for actuating the double scissor lift, a lead screw, which is rotatably mounted in the expansion segment so as to be orientated in the movement direction (19g) of the robot.

2. Robot according to claim 1, characterized in that the expansion segments respectively have two double scissor lifts which can be expanded in opposite directions and can be actuated together via the lead screw.

3. Robot according to claim 1, characterized in that all segments are coupled together via connection pieces.

4. Robot according to claim 3, characterized in that the connection pieces are stiffened and torsionally rigid hose pieces (paragraph 0006).

5. Robot according to claim 1, characterized in that on the expansion segment forming the foremost segment, a lifting device is provided with a head mounted thereon and provided with at least one tool and/or measuring apparatus, wherein the lifting device is designed in particular to rotate and/or lift and lower the head.

6. Robot according to claim 5, characterized in that the lifting device has a drive element and a locking device, which are connected to one another by a connection shaft.

7. Robot according to claim 1, characterized in that two expansion segments coupled to one another by a connection piece are connected to the lifting device.

8. Robot according to claim 1, characterized in that it has at least two advancing segments located respectively between two expansion segments.

9. Robot according to claim 1, characterized in that at least two of the successive expansion segments can be rotated relative to one another, in particular in order to rotate these expansion segments by 90 degrees relative to one another.

10. Robot according to claim 1, characterized in that each advancing segment has a self-locking advancing mechanism for increasing or reducing the distance between the two expansion segments coupled to the advancing segment, wherein the advancing mechanism has a piston, which is mounted on the one end of a connection piece and which can be moved forwards and backwards by a spindle drive.

11. Robot according to claim 1, characterized in that its rearmost part is a plug segment, to which a main connecting plug of a supply cable, which is preferably in the form of a push cable, can be connected.

12. Robot according to claim 1, characterized in that it has an emergency power supply with electronics, which is preferably contained in the plug segment for the temporary further supply of internal control components if the supply is disrupted in order to retract the double scissor lifts of the self-locking expansion segments as well as the self-locking advancing mechanisms of the advancing segments and, if necessary, unlock the lifting device.

13. Robot according to claim 1, characterized in that at least one of the following belongs to the tools and/or measuring apparatuses mounted on the head: an ultrasonic measuring apparatus for measuring the thickness of the pipe wall, a laser measuring apparatus for 3D measurement of the pipe and deposits, a powerful light source for spot hardening a resin tube, a laser for cutting away material or engraving the pipe wall, a motor with a brush or a milling head.

14. Robot according to claim 1, characterized in that an image sensor with a view of the tool(s) is mounted on the head, to transmit a live image to an operating unit and to position the robot at a specific point.

15. Robot according to claim 1, characterized by programmed control for automatically moving to a defined point in the pipe or shaft system and/or for autonomous milling or grinding of pipe or shaft walls in previously defined areas.
